(19) United States
(12) Patent Application Publication
(10) Pub. No.: US 2015/0371522 A1
(43) Pub. Date: Dec. 24, 2015

(54) Multi-Station System for Pressure Ulcer Monitoring and Analysis

(71) Applicant: SENSIMAT SYSTEMS INC., Woodbridge (CA)

(72) Inventors: David Mravyan, Kleinburg (CA); William Frank Mann, Milton (CA)

(21) Appl. No.: 14/764,123

(22) PCT Filed: Jan. 28, 2014
(86) PCT No.: PCT/CA2014/050056

§ 371 Date: Jul. 28, 2015

Related U.S. Application Data
(60) Provisional application No. 61/757,408, filed on Jan. 28, 2013.

(51) Int. Cl. G08B 21/04; G06F 19/00; H04W 4/00

(52) U.S. Cl. CPC G08B 21/0461; H04W 4/008; G06F 19/3431

(57) ABSTRACT

A multi-patient pressure monitoring system for monitoring, prevention, and analysis of pressure ulcers. The system includes a server, monitoring stations, and mobile communication terminals. Each of the monitoring stations are configured to detect physical properties including at one of pressure, temperature, and moisture, in relation to a respective contact surface. The server includes a controller configured for: receiving inputs including the detected physical properties from the monitoring stations, determining a risk value at each monitoring station using the risk assessment model based on the received inputs and patient information, determining a priority of each monitoring station in dependence of the determined risk value, and communicating the determined priority of the stations to an output interface. The server can track and correlate radio frequency identification (RFID) activation between the mobile communication terminal and one of the stations, the time of the proximity being associated with the patient turn at the station.

### CROSS-REFERENCE TO RELATED APPLICATIONS

This application claims the benefit of priority to U.S. Patent Application No. 61/757,408 filed Jan. 28, 2013, the contents of which are hereby incorporated by reference.

### FIELD

Example embodiments described herein relate generally to systems for monitoring pressure; and, in particular, to a multi-patient system for pressure ulcer monitoring, prevention, and analysis.

### BACKGROUND

The skin of people confined to a bed or wheelchair is susceptible to decubitus ulcers, commonly referred to as pressure sores, bedsores, or pressure ulcers (PUs). Pressure against the skin from prolonged periods of non-movement can result in lesions on the skin of various degrees of severity (4 stages) of PUs. These skin lesions are painful, can significantly increase the risk of serious infection, and could result in death. PUs can occur in people that are in wheelchairs or are confined to a bed, but can also occur during short-term hospital stays after surgery (Woodbury, M. G. & Houghton, P. E. (2004): “Prevalence of pressure ulcers in Canadian healthcare settings” Ostomy Wound Manage 50). Prevention of PU formation is a major concern in patient care. In Canada, the prevalence of PUs is estimated to be up to 30% in Long-term care (LTC) settings, 25% in acute care settings, and 15% in community care settings. The total cost of PUs for the healthcare system in Canada is approximately $2.1 billion annually (Toronto Health Economics and Technology Assessment Collaborative (2008): “The cost-effectiveness of prevention strategies for pressure ulcers in long-term care homes in Ontario: Projections of the Ontario Pressure Ulcer Model”). The annual cost to healthcare institutions in the US is approximated at $12 billion. Additionally, more than 17,000 lawsuits related to pressure ulcers are filed annually in the United States (Berlowitz, D., Lukas, C.: “Preventing pressure ulcers in hospitals”, Agency for Healthcare Research and Quality, release date April 2011).

The potential to spare individuals from additional medical complications and to reduce healthcare and legal costs by managing the problem of pressure ulcers through prevention is substantial. However, the most common current intervention is simply turning the patient at regular intervals. Many patients still suffer from pressure ulcers due to a variable build-up of pressure, moisture, and temperature that is not adequately relieved.

When a healthcare practitioner performs a patient procedure, in some medical systems, the practitioner needs to retrieve the patient chart, correctly identify the patient, and/or manually enter all of the details of the procedure at that time. Alternatively, the practitioner can make notes or update the charts and enter the details later into a computer system. This can be a slow and cumbersome process, and may be prone to errors, especially when the practitioner needs to move onto the next patient.

In some conventional health care settings which have policies for addressing pressure sores, the caregivers are to perform their routines with a specific time regimen, such as maintaining a 2 to 4 hour patient turning schedule.

These and other difficulties may be appreciated in view of the detailed description of example embodiments, below.

### SUMMARY

At least some example embodiments relate to a pressure ulcer monitoring and analysis system to assist medical professionals, administration staff and patients in monitoring, preventing, and analyzing pressure ulcers (PUs). The system includes a number of monitoring stations. Example embodiments include a mat device, with sensors, which is placed underneath the bed sheets on the mattress or inside of the wheelchair cushion. The monitoring station, through the mat device, measures patient pressure, moisture and temperature at a contact surface, and records, and transmits the collected data wirelessly to a central server. The central server includes software which runs a risk assessment algorithm based on clinically proven and tested recommendations, which can be further dynamically refined and updated through clinical testing and analysis, and/or real-time detected data from the sensors. The software then prioritizes patients connected to the system based on those that require the most urgent attention. Tracking of data and statistics can also be used by the hospital administration staff to implement best practices among the caregiver and nursing staff.

In accordance with an example embodiment, there is provided a monitoring station for monitoring pressure at a contact surface, including: a plurality of sensors for detecting physical properties of the contact surface, the sensors including at least one of pressure sensors, temperature sensors, and moisture sensors; a communication subsystem for communicating with a server device over a network; a controller for communicating information to the server device based on the physical properties detected by the sensors; a short-range communication device which contains at least identification information of the monitoring station, the identification information automatically being sent to a mobile communication terminal in response to proximity detection of the mobile communication terminal.

In accordance with another example embodiment, there is provided a server, including: a communication subsystem for communicating with a plurality of monitoring stations over a network, each monitoring station configured to detect physical properties including at least one of pressure, temperature, and moisture, in relation to a respective contact surface; and a controller configured for: receiving inputs including at least one or all of: the detected physical properties from the monitoring stations, patient information entered by a caregiver through a user interface device, electronic medical records accessible through an electronic medical records server, and updates to a risk assessment model, determining a risk value at each monitoring station using the risk assessment model based on the received inputs, determining a priority of each monitoring station in dependence of the determined risk value, and communicating the determined priority of the stations to a device.

In accordance with another example embodiment, there is provided a server, including: a communication subsystem for communicating with a mobile communication terminal and at least one monitoring station over a network, each of the monitoring stations configured to detect physical properties including at least one of pressure, temperature, and moisture, in relation to a respective contact surface; and a controller configured for: receiving inputs including at least the detected physical properties from the monitoring stations, determining a risk value based on at least the detected physical properties for each station and tracking the risk value over time, receiving, from the mobile communication terminal, notification of proximity between the mobile communication terminal and one of the stations, the time of the proximity being associated with performance of a specified action to reduce the cumulative pressure at the station, correlating the time associated with performance of the specified action to the tracked risk value, and communicating the tracked risk value and the correlated time associated with performing the specified action to a device.

In accordance with another example embodiment, there is provided a mobile communication terminal, including: a communication subsystem for communicating with a server device over a network; a user interface device for displaying existing patient information associated with at least one monitoring station, each monitoring station configured to detect physical properties including at least one of pressure, temperature, and moisture, in relation to a respective contact surface; a short-range communication device which contains at least a receiving device for receiving identification information from one of the monitoring stations, the identification information automatically being received in response to proximity detection of the station; and a controller configured for sending notification of the proximity detection to the server device, the time of the proximity detection being associated with performance of a specified action to reduce the cumulative pressure at the contact surface of the station.

In accordance with another example embodiment, there is provided a method for pressure monitoring and pressure ulcer prevention at a plurality of pressure monitoring stations, each configured to detect physical properties including at least one of pressure, temperature, and moisture, in relation to a respective contact surface, the method including: performing a specified action to reduce the cumulative pressure at the contact surface of one of the stations, and activating, in association with performance of the specified action, a short-range communication device of a mobile communication terminal by bringing the mobile communication terminal into proximity to the monitoring station.

### BRIEF DESCRIPTION OF THE FIGURES

Embodiments will now be described by way of example with reference to the accompanying drawings, in which like reference numerals are used to indicate similar features, and in which:

FIG. 1 shows a diagrammatic illustration of a multi-station pressure monitoring and analysis system in accordance with an example embodiment;

FIG. 2 shows a detailed block diagram of the system;

FIG. 3 illustrates an example use case of the system for healthcare providers, in accordance with an example embodiment;

FIG. 4 illustrates an example use case of the system for healthcare administration staff, in accordance with an example embodiment;

FIG. 5 illustrates an example user interface for updating patient information, in accordance with an example embodiment;

FIG. 6 illustrates an example user interface for monitoring and analysis, in accordance with an example embodiment; and

FIG. 7 illustrates an example diagrammatic implementation of a risk assessment and priority algorithm, in accordance with an example embodiment.

### DETAILED DESCRIPTION OF EXAMPLE EMBODIMENTS

Example embodiments relate to systems and methods for pressure monitoring and analysis for a number of patients, for applications such as pressure ulcer prevention at multiple patient stations.

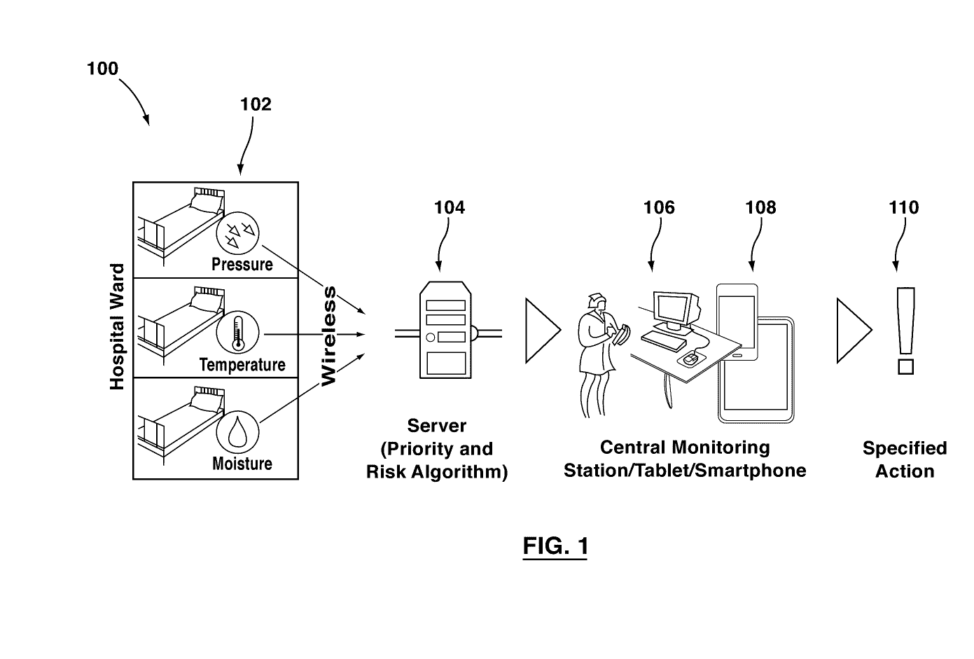

Reference is first made to FIG. 1, which illustrates a pressure monitoring and analysis system 100 in accordance with example embodiments. As shown in FIG. 1, the system 100 includes a plurality of monitoring stations 102 (one shown here), a server device 104, and terminals including a central monitoring terminal 106 and one or more mobile communication terminals 108. The server device 104 can be configured to implement a risk assessment and priority algorithm, described herein in greater detail. The system 100 provides the administrators of the healthcare institution a dashboard to assess, monitor, record and implement pressure relieving behaviour through analysis of key performance indicators. In example embodiments, the server device 104 sends, to the mobile communication terminal 108, an indicator or instructions to the practitioner for performing of a specified action 110 at the particular monitoring stations 102. The specified action 110 may be, for example, an action to reduce the cumulative pressure, such a turning of the patient. The particular priority or priority order of the action 110 can be presented to the practitioner, who will then perform the action according to the priority.

In an example embodiment, the specified action 110 does not require discretion, judgment, or professional skill. Rather, the specified action 110 can be performed by a caregiver with a specific direction as to that action.

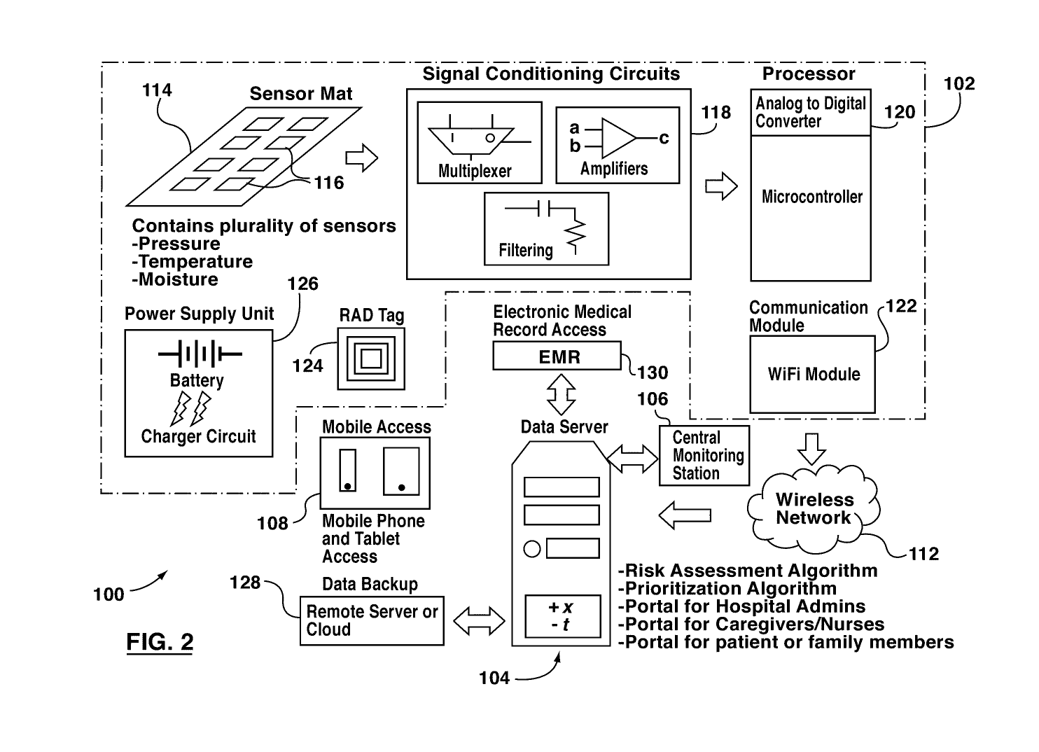

Reference is now made to FIG. 2, which illustrates a detailed diagrammatic view of the system architecture of the system 100. In some example embodiments, the server device 104 is included in the central monitoring terminal 106. In other example embodiments, the server device 104 is a separate device which can be accessed by the terminals 106, 108 over a network 112 which can include intranet, extranet, peer-to-peer, and/or the Internet. In some example embodiments, at least some of the algorithm, functions, or stored data described herein with respect to the server device 104 can be performed by the mobile communication terminal 108.

Each monitoring station 102 includes a mat device 114 for beds including, for example, a non-intrusive mattress overlay device designed to measure pressure, temperature, and moisture of a bed-ridden patient. The mat device 114 can be installed on top of the existing bed mattress, underneath the linens, or underneath the existing bed mattress. Data is acquired from sensors 116 in the mat device 114 and wirelessly transmitted to a central server device 104 where it is stored, and further analyzed for at least the risk assessment and priority algorithm.

Access to the data stored by the server device 104 is provided through a graphical user interface application designed and implemented for the mobile communication terminals 108 such as mobile devices, smartphones, tablets, laptops, and personal computers. The central monitoring terminal 106 and the mobile communication terminal 108 may include a touchscreen. Other input devices may include cursor-navigating devices (e.g. mouse or keyboard), and microphone (e.g. for voice input and voice commands). Example output devices include a display screen, and a speaker (e.g. for audio output). A dedicated application or “app” can be used in some example embodiments. In other example embodiments a general web browser may be used to access the server device 104 over the network 112 which includes an intranet, extranet, and/or the Internet.

Modification access rights to the data server 104 can be provided by way of portals, which can be web-based (HTTP) or application specific. At least hospital staff, including hospital administrators and caregivers, can be provided with access and modification rights. In some example embodiments, the patient can be provided with at least some access rights, and at least some modification rights, depending on the particular application or policy of the facility. For example, for home-based homecare implementations, the patient or family member may be provided with at least some self-management of the portal, where the user can self-monitor some of their own statistics, risk assessments, and priority.

Thus, in some example embodiments the server device 104 can be internally associated with a given facility, or can be a remote off-site server device. Further, the server device 104 may be used to collect and analyze information from multiple facilities (which each can have multiple monitoring stations 102). The aggregate or large data of information that is received can be recorded and used for tracking and assessment purposes. For example, the received data can be used to improve or dynamically update the risk assessment and priority algorithm, either based on aggregate (e.g. average) data and/or data specific to a particular patient.

In an example embodiment, the mat device 114 is comprised of thin layer of foam between two medical grade sheets of fabric which are ultrasonically welded or bound together (e.g. Herculite Fusion III, as would be understood in the art). In order to facilitate the cleaning or replacement of the mat device 114, the electronics may be disconnected, swapped, replaced, or exchanged. The surface fabric is made out of waterproof, anti-microbial, fire resistant material with unique stretch properties. The mat device 114 has built in sensors 116 to detect pressure, temperature and moisture. The signals are connected to signal conditioning circuitry 118 which is composed of signal multiplexers, amplifier circuits and signal filters. The filtered sensor signals are sampled by the analog to digital converter and recorded by the microcontroller 120. The sensors 116 may either directly measure the variables at the contact surface of the mat device 114, or can be used to infer or correlate such variables, such as when the sensors 116 are nested within one or a few layers under the contact surface.

The microcontroller 120 is connected to a communication module including a wireless module 122 (e.g. WiFi) which is connected to the data collection server 104 though the wireless network 112. Other protocols outside of WiFi may be used, including wired (e.g. Ethernet Local Area Network) or otherwise wireless protocols. The WiFi network 112 router infrastructure can be installed as part of the system installation or be built into the existing wireless network of the institution. The WiFi network 112 facilitates the connection of the bed sensors 116 from multiple monitoring stations to the one central data server.

The data server 104 acquires and stores the data from the monitoring stations 102. The data is analyzed by the risk assessment and priority algorithm, executable by the server 104, and prioritizes patients that are at risk of developing a pressure ulcer. The algorithm can also detect whether the patient is in the bed or not by analyzing pressure levels and temperature levels, for example. The server 104 can detect whether the patient had an incontinence episode by monitoring the moisture sensors as well as detect the level of mobility of the bed ridden patient and confirm their turning schedule. The algorithm uses metrics defined for the patient in the patient profile. The patient profile contains patient characteristics, for example: weight, Braden Scale (sometimes called Braden Score), and location of previously acquired pressure ulcers. More or less parameters may be considered for the algorithm in other example embodiments. For example, it is recognized herein that the Braden Scale does not traditionally does not rely on detected pressure values or temperature values, let alone such values detected in real-time from the sensors 116.

Data in the patient profile may be modified or updated by the caregiver or automatically retrieved from the electronic medical record (EMR) 130. Updates to the electronic medical record 130 are also possible and are achieved through the integration of the data server 104 into the existing electronic medical record 130. Power is supplied to the monitoring station 102 from the onboard battery 126, which can be recharged through a wall mount adapter. This allows mobility of the monitoring station 102, such as when rollaway beds are used. A radio frequency identification (RFID) tag 124 is built into the monitoring station 102 to interface with RFID readers integrated within the mobile communication terminal 108 that the caregivers, nurses or hospital staff may be using. Data on the server 104 may be backed up to an additional backup server or encrypted cloud service 128.

In an example embodiment, the RFID tag 124 is a passive tag which is activated when in proximity to an RFID reader, and does not require its own power source. In some example embodiments, each RFID tag 124 includes identification information associated with the particular monitoring station. This identification information can then be associated or assigned to a particular patient occupying the bed of the monitoring station, based on correlation stored and administered at the data server 104. Thus, in some example embodiments, the RFID tag 124 itself may not contain sensitive personal information of the patient, and can be easily re-used for the next patient. In other example embodiments, the RFID tag 124 can be an active tag having its own power source, processor, and/or memory, etc. Such an active tag may be used for two-way communication, for example.

In some example embodiments, Near Field Communication (NFC) and related protocols are used to communicate between the monitoring station and the reader, to be used as a “tag” to represent that the caregiver has attended to the patient, to automatically retrieve the particular patient data and/or to represent performance of the specified action. Note that NFC permits two-way communication between endpoints. Other short range proximity devices can be used so long as they can be readily activated by “tagging” or “tapping”, in other example embodiments.

In some example embodiments, the communication module (e.g. WiFi module 122) can be used for other devices to communicate with the monitoring station 102. A specific application program interface (API) can be provided to facilitate the sending and receiving of any data, including data obtained from the sensors 116.

Risk Assessment and Priority Algorithm

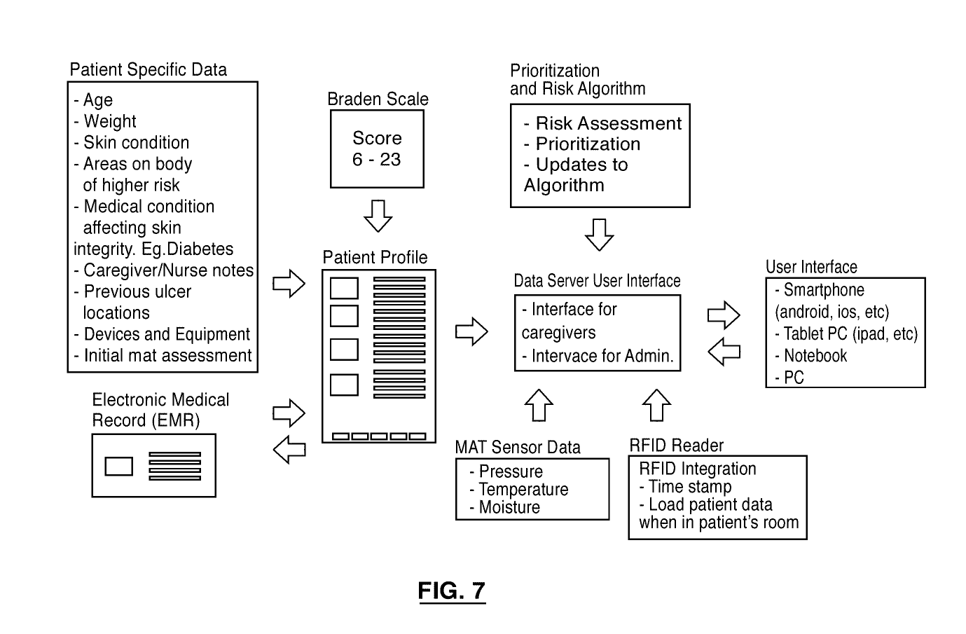

Reference is made to FIG. 7, which illustrates an example implementation of the risk assessment and priority algorithm, in accordance with an example embodiment. With the risk assessment and priority algorithm, the server device 104 is configured to alert the caregiver of degrees of risk for multiple patients, and alert when a particular patient is at risk of developing a pressure ulcer and prioritize patients based on their risk profile. The risk assessment and priority algorithm can specify which patients need to be turned, in which direction they should be turned, as well as suggest which order the nurse should attend to the patients. The prioritization is based on the risk assessment, patient profile and the physical location of the patient. The risk assessment is based on, for example, the clinically validated Braden Scale, which will include simple diagnoses for sensory perception, moisture, activity, mobility, nutrition, friction, and shear. The risk assessment and priority algorithm is further updated from the patient profile, which keeps track of patient data, such as age, weight, mobility, preconditions, previous ulcers, additional notes from the caregiver, doctor or nurse, devices and equipment (e.g. mattress or cushion types), and initial mat assessment. Therefore, in some example embodiments, other inputs and other patient information in addition to the Braden Scale is used in the calculation of the patient risk. The algorithm can be implemented in the form of at least one or all of method(s), model(s), formula(s), table(s), or algorithm(s).

The risk assessment and priority algorithm calculates risk based on inputs from the sensors 116 of the monitoring stations 102 combined with settings and selected options in the patient profile. The risk assessment and priority algorithm takes into account clinical research findings regarding the amount of pressure allowed for bed ridden or wheelchair bound patients, which it uses to set limit thresholds. This will allow multiple caregivers to remotely monitor and act on the status of their patients, access data and update patient profiles. Additional updates to the threshold levels, timing intervals, and alarms can also be made to the algorithm. The algorithm can be updated, typically by a network administrator or facility manager, to account for advances in risk analysis and/or clinical trials. Note that the Braden Scale does not traditionally take into account pressure detection, which is a variable that is detected by the monitoring stations 102 and can be accounted for by the risk assessment and priority algorithm. A total risk value can be calculated and tracked over time for each patient, using the algorithm.

In some example embodiments, the algorithm is dynamically updated based on received patient data from the sensors 116 and/or patient progress (e.g. occurrences of bedsores). This updating can be based on the collective patient data in the aggregate, and/or the patient data of the specific patient.

In example embodiments, the pressure sensors are arranged in a matrix without having to cover the entire surface area of the bed, this could be achieved without having to create a sensor matrix of thousands of sensor elements. The algorithm analyzes the signals and clusters pressure readings into sensor subsets, which are used for analysis. The pressure readings over time are compared to predefined thresholds established for the patient from the patient profile. Temperature readings are taken at different locations on the mat device 114. Temperature is a contributing factor to pressure ulcer formation and the algorithm adjusts the severity of the risk profile for pressure readings in areas of higher temperature. The moisture sensors are used for multiple purposes. First, higher moisture levels lead to an accelerated development of pressure ulcers. Therefore, the algorithm adjusts the risk in areas of the mat device 114 where moisture readings are higher than normal. Second, if the patient is prone to episodes of incontinence, the data server 104 is able to detect and alert the nurse of the incidence, preventing the prolonging of patient discomfort and further decreasing the risk of pressure ulcer development in exposed areas. The moisture sensor pads may be detached and replaced from the mat device 114 once they have become too moist. An alert to exchange the moisture sensors can be notified to the caregiver.

The patient profile is setup by the caregiver in order to provide a custom risk assessment for the patient. The profile takes into account the patient Braden Scale, any previous pressure ulcer related injuries, locations on the body that may be at a higher risk for that particular patient, whether the patient is more susceptible to skin breakdown or has issues with blood clotting as well as the patients other metrics pulled into the algorithm from the data server or via the integration with the electronic medical record 130 system of the institution.

Initial mat assessment refers to initially testing of a patient onto the monitoring station 102, or at least the sensor mat 114, and obtaining some initial information from the patient. For example, the information can be based on whatever specific patient area “hotspots” are found. For example, one location on the patient is determined to be much bonier than all other locations by way of the sensors 116, and the algorithm can be updated to have a lower threshold or quick warning alerts, for example.

In example embodiments, a weighting is used for each of the variables in order to determine the custom risk assessment. The particular weightings of each of the variables may depend on the particular application. A default weighting of the variables may be used, at least initially. In some example embodiments, the Braden Scale is given a weighting of more than the remaining variables, for example least half (50 percent).

Alerts to the caregiver are presented in a graphical user interface on the central monitoring terminal 106 or can be accessed by the caregiver remotely through their mobile terminal 108. The algorithm prioritizes patients based on the data collected above and allows the caregiver to tend to the most at risk patients. Caregivers are also alerted if sensor threshold levels are exceeded for a particular duration of time.

The priority based on the determined can be an ordered list of the patients or stations 102, shown in the order of priority along with the indicator of the determined risk. Through the user interface, selection of one of the patients on the list can cause the terminal 108 to retrieve and display the patient information. For a more graphical implementation, the priority can be shown on an interface which is tailored to display the actual floor layout of the hospital ward where the system is implemented, using a suitable indicator. In example embodiments, a priority level can be assigned to the stations 102 shown on the graphical layout, for example using any suitable indicator such as symbols, number scale (e.g. 1-4), colours (e.g. green for low priority, yellow for medium priority, and red for high priority), flashing for highest priority, etc. Emergency priority levels may be, for example, accompanied by an audible alert. The priority is typically updated to the mobile communication terminals 108 from the server 104 in real or near real-time.

In an example embodiments, one fixed route or priority order is determined and displayed for one caregiver to “pick-up”, to complete their particular rounds (including patient turns) based on that order. That caregiver or another caregiver can then receive or “pick-up” a next fixed route or priority order for their particular rounds. This type of system may be less dynamic but may integrate better with existing policies of the particular facility.

In some examples, if all of the patient information is not available to calculate the total risk according to the algorithm, the missing patient information may be given a default value. In some example embodiments, the default can be an average patient value, such as body temperature as a default value for temperature, or an average value according to the Braden Scale. In another example embodiment, the default value can be the worst case scenario e.g. according to the Braden Scale. In another example embodiment, the default value can be the best case scenario e.g. according to the Braden Scale. Again, the Braden Scale can be one of a number of parameters that are considered to determine the patient risk. One example implementation calculates the total risk from the aggregate or sum of the individual risk values and inputs (with appropriate weight or normalization, as appropriate), although other models or algorithms may be used in other example embodiments. In some example embodiments, any subset such as one variable or a calculated sub-group of the variables can be tracked and monitored as a risk value.

Application for Caregivers and Nurses

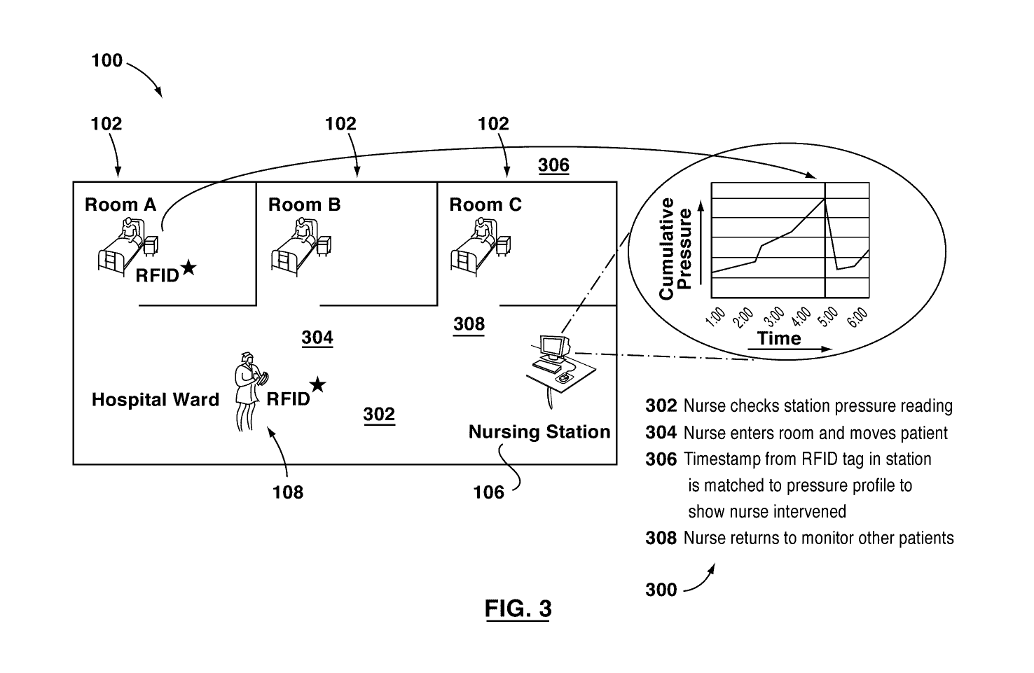

The application and use case method 300 for caregivers and nurses utilizing the system 100 is illustrated in FIG. 3. The server 104 is able to monitor, record, analyze and track pressure, moisture, and temperature at the respective contact surface of the beds (mats 114) at each monitoring station 102. The central data server 104 receives signals or data from a plurality of pressure, moisture, and temperature sensors 116 positioned at different locations in relation to the respective contact surface. Based on the received information from each monitoring station 102, the present risk and associated priority of the patient can be calculated by the server 104. In some example embodiments, at least one risk value such as the cumulative pressure of each patient is calculated and tracked over time by the server 104. For example, the cumulative pressure can be calculated based on detection by the pressure sensors, over time. The cumulative pressure can be determined how much pressure is accumulating, and similarly how much pressure was alleviated by a patient turn or other patient activity. The pressure, moisture and the temperature are also tracked over time by the server 104, and stored locally and/or remotely. The server 104 can plot these variables over time onto a graph, for example.

The server 104 is configured for comparing one or more values associated with a subset of the sensors 116 with a previous one or more values associated with a subset of values of the sensors 116. Utilizing the risk assessment and priority algorithm the server 104 determines whether a particular sensor 116 exceeded a calculated risk threshold and assigns a danger setting to that user. The danger setting for the user is used to prioritize the patients in the ward so that the caregiver is able to tend to the patients with the highest assessed risk of developing a pressure ulcer. The server 104 can also track metrics such as: time in bed, time out of bed, frequency of turns, and time stamp events. The servers 104 notifies the terminals 106, 108 how and when the patient should be repositioned in order to provide support for the caregiver and help alleviate the potential risk of pressure ulcer development. The server 104 can monitor whether the temperature in the bed has exceeded a prescribed threshold as well as alert the caregiver in circumstances of incontinence. In an example embodiment, the rate of change of the risk assessment value triggers the alert to the caregiver terminal 108. In an example embodiment, the rate of change of any one specified variable triggers the alert to the caregiver terminal 108.

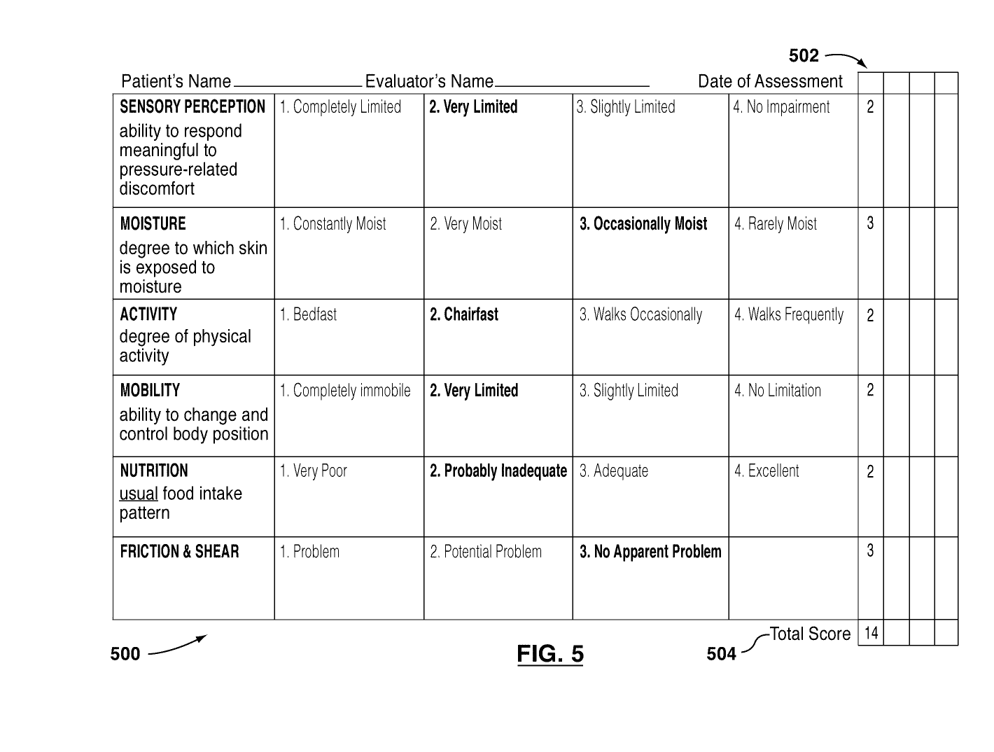

Through the mobile communication terminals 108, the caregiver can access a graphical user interface. In an example embodiment, the graphical user interface can be tailored to display the actual floor layout of the hospital ward where the system is implemented. For example, each monitoring station 102 can be represented on the user interface by a user-selectable icon, which upon selection retrieves and displays a configurable patient record onto the user interface (e.g. as shown in FIG. 5). The caregiver will have the advantage of monitoring multiple patients through a single platform which results in increased operational efficiency. The current standard of care requires that nurses or caregivers assess the risk of a patient using the Braden Scale, periodically update this information throughout the patient's stay as well as turn the patient every 2 to 4 hours. In accordance with example embodiments, the system 100 will allow the nurse to input patient information associated with the priority and risk algorithm, including at least the Braden Scale (e.g. using the interface shown in FIG. 5), when the patient is first admitted to the bed, and update the parameters electronically resulting in saved time and paperwork. The system 100 also allows the caregiver to monitor multiple patients at one time through the use of the central monitoring system 106. An action such as turning of the patient can be readily input and tracked by the data server 106 by comparing the RFID tag 124 associated with the monitoring station 102 of the patient and the monitoring station 102 sensor values from the sensors 116 within a specific time period of caregiver intervention.

Use Case Example for Caregivers and Nurses

For example, a number of caregivers are responsible for twenty bed-ridden patients in their ward. Some conventional procedures require the caregivers and nurses to perform their routines, check on the patients, tend to their needs and maintain the 2 to 4 hour patient turning schedule. With the monitoring station 102 installed on each of the twenty beds, the caregivers have real time or near real time access to data generated by the assessment and priority algorithm which outputs the patient prioritization schedule. Caregivers will be able to access the data wirelessly through their communication terminal 106 or 108, as they are making the rounds through the ward. As alerts on patients come in on their terminal 108 and are prioritized by the server 104, caregivers are able to tend to the patient(s) at the highest risk first, update any profile settings for the bed ridden patient, update the Braden Scale as well as make notes regarding skin condition of the patient. The server 104 is configured to keep track of all sensor data, log alarms, keep track of elapsed time since previous patient position change or turn, as well as record the time spent in and out of bed.

As illustrated by the method 300, at event 302 the caregiver checks the pressure reading graph displayed on the centralized station 106 or the mobile communication terminal 108, and other associated instructions, for the particular monitoring station 102. At even 302, the caregiver enters the room associated with the monitoring station 102 and RFID tags the mobile communication terminal 108 with the monitoring station 102. The caregiver then performs the patient turn. At event 306, based on the RFID tag event the mobile communication terminal 108 automatically sends a communication to the data server 104, which is recorded as a timestamp onto the pressure reading graph to show that the caregiver performed the patient turn. At event 308, the caregiver views the centralized station 106 or the mobile communication terminal 108 to monitor one of the other patients.

Reference is now made to FIG. 5, which shows an example graphical user interface 500 which is displayed on the communication terminal 106 or 108. The graphical user interface 500 shown, for example, corresponds to at least the Braden Scale. Additional information or parameters may be displayed and updated through user input in example embodiments, as described in detail herein with respect to the risk and prioritization algorithm. By using a suitable user input device such as a touchscreen, the caregiver can update the patient information by selecting the appropriate box, e.g. using a touchscreen which can be more intuitive. Each of the illustrated boxes on the interface 500 can be selected, wherein selection of a scale number for one of the variables accentuates (e.g. bolding) that box, while de-accentuating any of the other scale numbers for that variable. Some of the variables, such as moisture, activity, mobility, can be automatically and dynamically updated on the interface 500 based on data received from the sensors 116.

While at the monitoring station 102, the patient record may be automatically retrieved by tapping the caregiver's RFID reader onto the RFID tag 124 of the monitoring station 102, and result in the record being automatically displayed on the communication terminal 108. Also, the patient total scores 502 can automatically be updated based on the selected boxes on the interface 500.

Successful tapping or proximity of the RFID tag 124 can also result in an indicator being output on the communication terminal 108 and/or the monitoring station 102. Examples include an icon, image, font change, flash, or other graphic rendering onto a display, an audible alert through the speaker, and/or activation of at least one LED (e.g. continuous or flashing), etc. The communication terminal 108 may include a user interface that allows the user to manually negate the detected proximity such as when the RFID tag 124 is accidental activated.

The data server 106, upon receiving the tap event, is configured to retrieve the record and send toon the communication terminal 108 of the caregiver. In other example embodiments, the patient record may be retrieved by selecting an icon representing the particular monitoring station, e.g. using the touchscreen, through a graphical user interface which is tailored to display the actual floor layout of the hospital ward. The caregiver may also manually enter the patient identifier by patient name or patient number, for example.

Once the patient record is retrieved, the user interface 500 of FIG. 5 is displayed, with the particular boxes blank if there is no previous patient information or if this the first instance for the patient record. If there is already patient information available, the particular boxes representing the applicable score are already indicated (e.g. bolded, as shown, or highlighted or differently coloured). Based on examination or consultation of the patient, the caregiver may make any updates to the patient information through the graphical user interface 500, e.g. using the touchscreen. The scores 502 and total scores 504 on the user interface 500 are automatically calculated and displayed in response to the received user inputs. Some of the scores, such as the level moisture, activity, and/or mobility, may be automatically populated and/or updated by the server 104 based on the variables detected by the monitoring station 102.

As understood in the art, according to the Braden scale, each category is rated on a scale of 1 to 4, excluding the ‘friction and shear’ category which is rated on a 1-3 scale. This combines for a possible total of 23 points, with a higher score meaning a lower risk of developing a pressure ulcer and vice-versa. A score of 23 means there is a low risk for developing a pressure ulcer while the lowest possible score of 6 points represents the severest risk for developing a pressure ulcer. According to the Braden Scale assessment score scale: Very High Risk: Total Score less than 9; High Risk: Total Score 10-12; Moderate Risk: Total Score 13-14; and Mild Risk: Total Score 15-18. In some example embodiments, a total risk value can be calculated which includes using scores from the Braden Scale. Note that the Braden Scale associates lower values as higher risk, which can be accounted for (e.g. inverted, if necessary) in calculation of the total risk value. For example, total risk=f(detected physical properties from the monitoring stations, patient information entered by a caregiver through the user interface, electronic medical records).

It would be appreciated that the algorithm can take into account more detailed information or variables than the traditional Braden Scale, referring again to FIG. 5, wherein such other variables will also affect the risk of pressure ulcers. For example, the Braden Scale has only a limited number of discrete ranges from e.g. 1 to 4 or 1 to 3. Example embodiments can detect more accurate levels of the variables used in the Braden Scale. For example, the moisture variable received by the algorithm may not be limited to the 4 discrete levels of the Braden scale, as the moisture sensor of the stations 102 can provide greater accuracy and a more exact detected moisture amount. The detected values can then be represented as a decimal on the Braden Scale, half-intervals, different normalizations or weights, or using a greater scale. Similarly, the level of activity or mobility, typically limited to 4 discrete levels according to the Braden Scale, can be determined in real-time based on the detected actual patient activity using at least the pressure sensors, and the remaining sensors 116, therefore having greater accuracy for the risk assessment and priority algorithm.

Application for Hospital Administrators

Through the terminals such as the mobile communication terminals 108 or the central monitoring terminal 106, the application and associated user interface for hospital administrators may be based on the same platform provided for the caregiver and nursing staff. One additional feature may be implemented in the user interface client, which may interact with the data stored on the data server device 104 of the system 100. Administrators are able to track key performance metrics of their staff, with respect to patient turning schedules and skin care. The data stored and tracked by the server 104 can be used by hospital administrators to track staff performance, have a record and timestamp of interactions between patients and caregivers as well as analytics tools to track progress. The data server 104 of the system 100 is configured to keep track of alarm frequencies, type of alarm alerts, as well as patient turning schedules. The administrators can compare shift over shift progress, track alarm incident and day to day, week to week, month to month progress. Administrators are also able to compare a variety of staff members, and track their performance. Utilizing the system 100 can assist hospital administrators with reporting metric guidelines, quality of care reports and overall continuous improvement to the quality of care. The server device 104 is further configured to encrypt data for transfer and secure storage on the data server 104 as well as backup data the cloud storage service 128 or through a secondary server. Reports generated by the data server 104 with respect to patient turning frequency and quality of care, may be used to decrease liability in litigation cases with pressure ulcers. Reports may also be used to prove the delivery of care to private and public payers (e.g. Medicare™, Bluecross™, Blueshield™, etc.).

In some example embodiments, other events can be input through a user interface, or tagged through an RFID reader integrated within the mobile communication terminal 108. For example, the time that a new pressure ulcer is found on a patient can be tagged or indicated onto the risk value graphs. This can be used for analyzing and to update the risk assessment model, which may require a lower threshold or higher urgency values as a result when it is determined that there is a systematic occurrence of new pressure ulcers being found at a given facility or system. This data may be used to manually or dynamically adjust the weights or normalization of variables for the risk assessment and priority algorithm, for example.

Use Case Example for Hospital Administrators

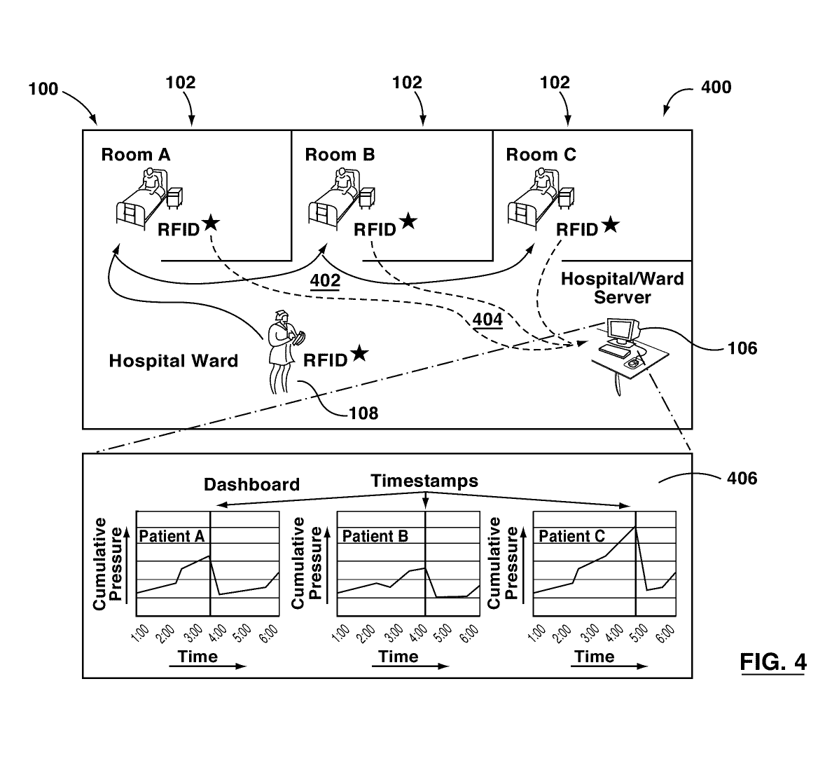

An example use case method 400 for hospital administrators is illustrated in FIG. 4. As shown in FIG. 4, the nurse or caregiver is making the daily rounds between the patients in the ward. At event 402, every time the caregiver enters the patient's room, to perform the patient turn or other specified action, the RFID tag 124 on the monitoring station 102 is read by an RFID reader that is integrated within the mobile communication terminal 108 that the caregiver is carrying. At event 404, this interaction is time stamped on the data server 104 and is matched to the pressure, temperature and/or moisture readings within a specific time window before and after that event. At event 406, these variables can be plotted onto a graph, along with a timestamp of the turn event. Administrators are able to look through historic data of patient care delivery by the specific caregiver, or all of the caregivers who gave treatment to that patient. The server 104 can be configured to provide notification of implementing a successful turn schedule, pressure relief and period skin assessments. Day to day changes, frequency of alarms, and turning schedules can be tracked by hospital administrators in order to assist with continuous improvement to best practices, increased efficiency and improvements to the quality of care.

In the example shown in FIG. 4, at event 406, one risk value such as pressure or the cumulative pressure is tracked, and can be with the patient turn event. In other example embodiments, other parameters are tracked and tagged with the patient turn event, such as the calculated total risk value, which can include consideration of the pressure or cumulative pressure values.

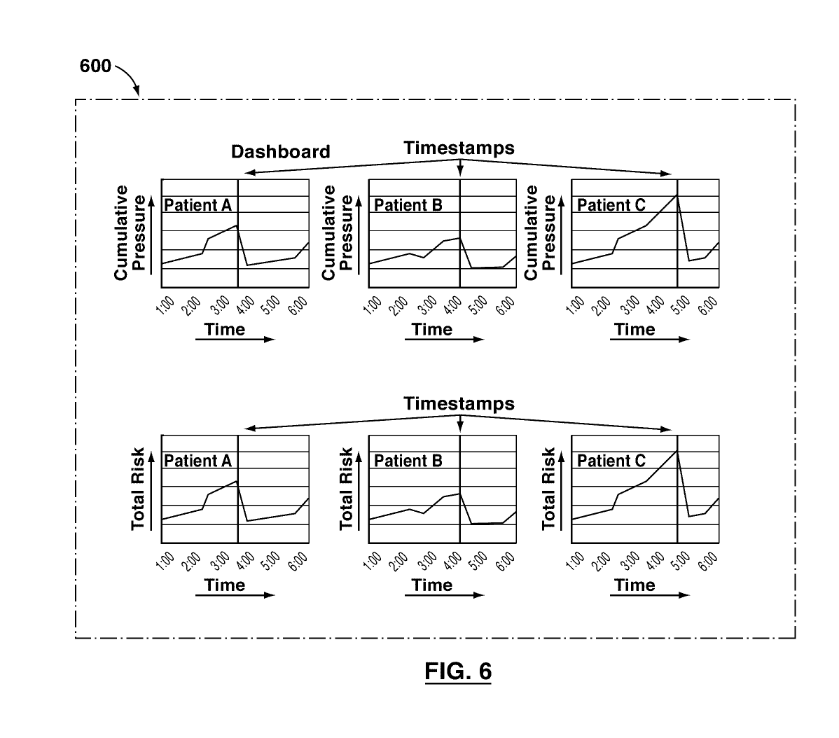

Referring now to FIG. 6, an example user interface 600 which displays graphs of both the cumulative pressure and the total risk value is illustrated, for use by administrators and/or caregivers, as appropriate. The illustrated graphs are for three example patients, Patient A, Patient B, and Patient C. Other risk values may be shown on graphs over time, such as pressure, moisture and/or temperature, any variables detected by the sensors 116, the total Braden Score, and/or other individual variables from the Braden Scale. In some example embodiments, more than one of the variables may be shown (plotted) on the same graph. In some example embodiments, variable plots may be dynamically added or removed from display on the graph based on user input.

Referring again to FIG. 4, it would be appreciated that activating the RFID tag 124 allows the time of turning the patient to be correlated with the detected patient information or risk value, such as cumulative pressure. This may then be shown together on the graphs of the user interface 600. This contrasts with having to manually enter the time of the patient turn or specified action, which can be prone to errors. Other variables can be tracked over time and correlated with the performance of the patient turn action.

In example embodiments, the particular timing of activating the RFID tag 124 may depend on the policy of the facility. In one example policy, the caregiver activates the RFID tag 124 upon entering the particular monitoring station. The caregiver then performs the turning of the patient associated with the particular monitoring station 102. In some example embodiments, in such circumstances, the particular patient record can also be automatically displayed on the user interface of the terminal 108 in response to activating the RFID tag 124. This allows the caregiver to readily update the particular patient record without having to first manually retrieve or type in the patient identifier. In another example policy, the caregiver activates the RFID tag 124 only after successful completion of the turning of the patient.

In some example embodiments, other short-range wireless communication devices may be used and activated by merely tapping or placing the mobile communication terminal 108 in proximity to the monitoring station 102, for example Bluetooth™, NFC, or infrared technologies. Again, an alert on a display, speaker, or LED can be output to indicate successful proximity.

Alternatives can be provided in some example embodiments or applications. In some example embodiments, wounded veterans returning home by aircraft may be immobile during flight, significantly increasing the likelihood of pressure ulcer development as a secondary complication in transit. By retrofitting the beds in the aircraft with example embodiments of the described system 100, the military nurse may be able to detect the early development of an ulcer and tend to the patient, thus reducing the likelihood of infection, additional surgeries, and extension to hospitalization and recovery time.

In other example applications, such as homecare or a rehab setting, the system 100 may also detect whether the patient is present in the bed, track the amount of time spent in bed compared to out of bed, and monitor and cases of incontinence. In some example embodiments, the patient is equipped with his own mobile terminal 108 or RFID reader device so that the patient can tap in or tap out when leaving the bed, or when self-performing a turn.

Other actions can be pre-specified as being designated for the RFID reader tap event, in accordance with other example embodiments, which can be used to correlate with tracked changes in the detected or calculated variables, for analysis.

Referring to FIG. 1, in an example embodiments, the specified action 110 includes a specified medical treatment action. In an example embodiment, the specified action 110 includes a specified preventative treatment action. In an example embodiment, the specified action 110 includes a specified action to change a state to the patient. In some example embodiments, the specified action 110 includes a specific instruction, such as re-positioning the patient to relieve a particular region of high cumulative pressure, straightening the patient or posture of the patient, or positioning the patient to compensate for the accumulated pressure on one side by moving the patient beyond a straight posture to the other side. In some example embodiments, the specified action 110 includes a series or sequence of instructions or specified actions, such as performing a patient turn in one direction, and then performing a patient turn in another direction, for example. As well, the series of instructions can include performing a patient turn in combination with one or more additional specified actions. In some example embodiments, the particular specified action is sufficiently specific based on rules and algorithm stored in the data server 104, so that performing the specified action by the caregiver does not require discretion, judgment, or professional skill.

In another example embodiment of a specified action 110, referring now to FIG. 2, the sensor mat 114 can further include a plurality of inflatable regions or points (not shown), for example in a matrix configuration or a longitudinal row configuration. The inflatable regions can be controlled by the microcontroller 120 of the monitoring station 102, or manually operated by the caregiver based on the displayed specific instructions. Based on the particular risk assessment determined by the server 104, selected inflatable regions are activated to a degree of inflation based on instructions from the server 104. In one example, this is simply an increase or decrease of an inflation level of some or all of the inflatable regions, to cause a change of state to the patient. In another example, this specified action can be a sequence of inflations/deflations, for example to rock the patient back-and-forth, to relieve the cumulative pressure of the patient, for example.

In another example embodiment of a specified action 110, the bed of the monitoring station 102 is tilted, inclined, declined, folded, the head end and/or foot end only is inclined or declined, or any such sub-combinations or partial tiltings. In other example embodiments, the bed can be configured to tilt about the longitudinal axis of the patient body. The specified action can be a sequence of any such actions (e.g. back-and-forth) as determined and instructed by the server 104, based on the particular risk scenario. The bed control can be controlled by the microcontroller 120 of the monitoring station 102, for example, or manually operated by the caregiver.

In some example embodiments, the system 100 may also be used in non-medical settings. The system 100 can be retrofitted to install within seats in vehicles, or chairs at the workplace. The system 100 can be configured to provide posture analysis data, tracking and recommendations. The system 100 can be configured for pressure distribution analysis for the comparison of bed mattress quality.

Although some embodiments of the system 100 have been described with respect to mats or mattresses wherein the user is lying, it can be appreciated that example embodiments may be suitably modified for use in wheelchairs and wheelchair cushions wherein the user is sitting. Example embodiments may also be applied to footwear related articles such as insoles, wherein the user may be standing with or without assistance. Example embodiments may also be applied to other suitable applications where prolonged pressure may be applied to or from a user which may result in pressure sores if left unattended. Example embodiments may be used in applications where pressure may be applied unevenly along a contact surface, and wherein a user response may be required to compensate for the unevenly applied pressure.

In some example embodiments, an RFID tag 124 (or other short-range proximity device) is located within the terminal 108 while the RFID reader is located within the monitoring station 102. For example, the caregiver may tap or tag using their own ID badge, and the patient turn event timestamp is updated at the server 104 based on communications between the monitoring station 102 and the server 104.

While some of the present embodiments are described in terms of methods, a person of ordinary skill in the art will understand that present embodiments are also directed to devices including components for performing at least some of the aspects and features of the described methods, be it by way of hardware components, software or any combination of the two, or in any other manner. Moreover, an article of manufacture for use with the apparatus, such as a pre-recorded storage device or other similar non-transitory computer readable medium including program instructions recorded thereon, or a computer data signal carrying computer readable program instructions, may direct an apparatus to facilitate the practice of the described systems and methods. It is understood that such apparatus, articles of manufacture, and computer data signals also come within the scope of the present example embodiments.

While some of the above examples have been described as occurring in a particular order, it will be appreciated by persons skilled in the art that some of the messages or events or steps or processes may be performed in a different order provided that the result of the changed order of any given step will not prevent or impair the occurrence of subsequent steps. Furthermore, some of the messages or steps described above may be removed or combined in other embodiments, and some of the messages or steps described above may be separated into a number of sub-messages or sub-steps in other embodiments. Even further, some or all of the steps of the conversations may be repeated, as necessary. Elements described as methods or steps similarly apply to systems or subcomponents, and vice-versa. Reference to such words as “sending” or “receiving” could be interchanged depending on the perspective of the particular device.

The term “computer readable medium” as used herein includes any medium which can store instructions, program steps, or the like, for use by or execution by a computer or other computing device including, but not limited to: magnetic media, such as a diskette, a disk drive, a magnetic drum, a magneto-optical disk, a magnetic tape, a magnetic core memory, or the like; electronic storage, such as a random access memory (RAM) of any type including static RAM, dynamic RAM, synchronous dynamic RAM (SDRAM), a read-only memory (ROM), a programmable-read-only memory of any type including PROM, EPROM, EEPROM, FLASH, EAROM, a so-called “solid state disk”, other electronic storage of any type including a charge-coupled device (CCD), or magnetic bubble memory, a portable electronic data-carrying card of any type including compact flash, secure digital (SD-CARD), memory stick, and the like; and optical media such as a Compact Disc (CD), Digital Versatile Disc (DVD) or Blu-ray™ Disc.

Variations may be made to some example embodiments, which may include combinations and sub-combinations of any of the above. The various embodiments presented above are merely examples and are in no way meant to limit the scope of this disclosure. Variations of the innovations described herein will be apparent to persons of ordinary skill in the art having the benefit of the present disclosure, such variations being within the intended scope of the present disclosure. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present disclosure as a whole. The subject matter described herein intends to cover and embrace all suitable changes in technology.

1. A monitoring station for monitoring pressure at a contact surface, comprising:
a plurality of sensors for detecting physical properties of the contact surface, the sensors including at least one of pressure sensors, temperature sensors, and moisture sensors;
a communication subsystem for communicating with a server device over a network;
a controller operably connected to the sensors and for communicating information through the communication subsystem to the server device based on the physical properties detected by the sensors; and
a short-range communication device operably connected to the controller and which contains at least identification information of the monitoring station, the identification information automatically being sent to a mobile communication terminal in response to proximity detection of the mobile communication terminal,
wherein the proximity detection only occurs in association with performance of a specified action to reduce the cumulative pressure at the station.

2. The monitoring station as claimed in claim 1, wherein the short-range communication device includes a radio frequency identification (RFID) tag.

3. The monitoring station as claimed in claim 1, wherein the short-range communication device is a passive communication device.

4. The monitoring station as claimed in claim 1, wherein the proximity detection is associated with the physical properties detected by the sensors.

5. (canceled)

6. (canceled)

7. A server, comprising:
a communication subsystem for communicating with a plurality of monitoring stations over a network, each monitoring station configured to detect physical properties including at least one of pressure, temperature, and moisture, in relation to a respective contact surface; and
a controller operably connected to the communication subsystem and configured for:
receiving inputs including at least one or all of: the detected physical properties from the monitoring stations, patient information entered by a caregiver through a user interface device, electronic medical records accessible through an electronic medical records server, and updates to a risk assessment model,
receiving notifications, wherein each notification is of proximity detection between a mobile communication terminal and one of the monitoring stations, wherein a time of the proximity detection is associated with performance of a specified action to reduce the cumulative pressure at the contact surface of the one of the monitoring stations;
determining a risk value at each monitoring station using the risk assessment model based on the received inputs,
determining a priority order of each monitoring station in dependence of the determined risk value, and
communicating the determined priority order of the stations to a device.

8. (canceled)

9. The server as claimed in claim 7, wherein the priority order is communicated to the mobile communication terminal in real-time or near real-time.

10. (canceled)

11. (canceled)

12. The server as claimed in claim 7, wherein the controller is further configured for tracking the risk value of each monitoring station over time, and correlating a time associated with performance of the specified action to the tracked risk value.

13. The server as claimed in claim 7, wherein the risk assessment model includes the Braden scale model.

14. The server as claimed in claim 13, wherein the risk assessment model includes considerations of additional variables in addition to the Braden scale model.

15. The server as claimed in claim 7, wherein the risk assessment model includes a pressure ulcer risk assessment model, and wherein the risk value is a pressure ulcer risk value.

16-21. (canceled)

22. A mobile communication terminal, comprising:
a communication subsystem for communicating with a server device over a network;
a user interface device for displaying existing patient information associated with at least one monitoring station, each monitoring station configured to detect physical properties including at least one of pressure, temperature, and moisture, in relation to a respective contact surface;
a short-range communication device which contains at least a receiving device for receiving identification information from one of the monitoring stations, the identification information automatically being received in response to proximity detection of the station; and
a controller operably connected to the communication subsystem, the user interface device and the short-range communication device, the controller configured for sending notification of the proximity detection to the server device, wherein a time of the proximity detection is with performance of a specified action to reduce the cumulative pressure at the contact surface of the station.

23. The mobile communication terminal as claimed in claim 22, wherein the receiving device includes a radio frequency identification (RFID) reader.

24. The mobile communication terminal as claimed in claim 22, wherein the controller is configured to receive a priority order of which monitoring stations are to receive performance of the specified action.

25. The mobile communication terminal as claimed in claim 22, wherein the user interface device is further configured to display a priority order of which monitoring stations are to receive performance of the specified action.

26. The mobile communication terminal as claimed in claim 22, wherein the controller is further configured for receiving user inputs through the user interface relating to updating the patient information of the monitoring station, and sending the updated patient information to the server device.

27. The mobile communication terminal as claimed in claim 22, wherein the existing patient information is displayed in response to the proximity detection.

28. The mobile communication terminal as claimed in claim 22, wherein the existing patient information is received from the server device as a consequence to sending notification of the proximity detection to the server device.

29. The mobile communication terminal as claimed in claim 22, wherein the time of the proximity is determined by the controller.

30. The mobile communication terminal as claimed in claim 22, wherein the time of the proximity is determined by the server device.

31-38. (canceled)
